(19) United States
(12) Patent Application Publication
(10) Pub. No.: US 2013/0106701 A1
(43) Pub. Date: May 2, 2013

(54) INFORMATION PROCESSING APPARATUS AND METHOD THEREOF

(71) Applicant: Fujitsu Mobile Communications Limited, Kawasaki-shi (JP)

(72) Inventor: Yasuhiko ABE, Niiza (JP)

(73) Assignee: FUJITSU MOBILE COMMUNICATIONS LIMITED, Kawasaki-shi (JP)

(21) Appl. No.: 13/662,355

(22) Filed: Oct. 26, 2012

(30) Foreign Application Priority Data
Nov. 2, 2011 (JP) 2011-240878

(51) Int. Cl. G06F 3/041

(52) U.S. Cl. 345/168

(57) ABSTRACT

The information processing apparatus that can execute an application program includes a characteristic extraction unit configured to extract a characteristic range, a position setting unit configured to generate position setting information by making an association between the characteristic range and position coordinates of the characteristic range, and to store the position setting information in a storage unit, an execution control unit configured to select a characteristic range present in a direction indicated by an arrow key when an input is made with the arrow key, to output to a display control unit selection range information and selection display information, when a display portion of the display panel, which corresponds to the currently selected characteristic range is selected by using an Enter key, and the execution control unit generates decision information indicating that the display portion is selected, and to output the decision information to an input control unit.

### CROSS-REFERENCE TO RELATED APPLICATION

This application is based upon and claims the benefit of priority of the prior Japanese Patent Application No. 2011-240878, filed on Nov. 2, 2011, the entire contents of which are incorporated herein by reference.

### FIELD

The embodiments discussed herein are related to an information processing apparatus that can support a plurality of user interfaces, and a method thereof.

### BACKGROUND

Information processing apparatuses that employ a touch panel as a user interface sometimes adopt application programs for performing operations by using information input with the touch panel. Since such application programs are those prepared by assuming a touch interface, they do not sometimes support an information processing apparatus employing multi-function keys such as arrow keys, an Enter key and the like as a user interface. To make application programs support an information processing apparatus having multi-function keys as a user interface, the program need to be changed. Accordingly, it is needed to newly develop an application program. For this reason, it is demanded to provide an information processing apparatus with a mechanism that enables even an application program employing a touch panel to support an operation performed with a multi-function key.

As related techniques, an information processing apparatus having a touch panel on a menu selection screen including a plurality of items, arrow keys for instructing a move direction of a cursor, and an Enter key for instructing a process corresponding to a selected item to be executed is known. With the information processing apparatus, the cursor is moved and displayed according to a position instructed with not only an arrow key but the touch panel, and a process corresponding to a selected item is executed not only by operating the Enter key but by touching off the touch panel. However, if a touch input is continued for a predetermined duration or longer from a touch-on, and if a touch input is made outside an area, which corresponds to an item instructed at the start of a touch, by the time the touch panel is touched off, the process corresponding to the selected item is not executed. Alternatively, if a touch input is made outside a specified distance range from a position instructed at the start of a touch by the time the touch panel is touched off, the process corresponding to the selected item is not executed. As a result, operability at the time of a menu selection can be improved.

Additionally, a portable electronic appliance input method that easily makes a menu selection and input is known as a related technique. With this method, a display screen is partitioned into a plurality of display areas, in which a selection menu is displayed. If menu items are present under a menu selected on an arbitrary menu screen when an operator selects and inputs a menu item, the selected menu item is again displayed. As a result, the input method that produces high display efficiency and has a user-friendly menu structure can be provided.

Japanese Laid-Open Patent Publication No. 2006-318393

Japanese Laid-Open Patent Publication No. 10-312261

### SUMMARY

An information processing apparatus according to one embodiment, which can execute an application program operable by using a touch panel includes a characteristic extraction unit, a position setting unit and an execution control unit.

The characteristic extraction unit extracts a characteristic range by executing a characteristic extraction process for an image displayed on a display panel.

The position setting unit generates position setting information by making an association between the characteristic range and position coordinates indicating a position of the characteristic range on the display panel, and stores the position setting information in a storage unit.

The execution control unit selects a characteristic range at position coordinates present in a direction indicated by an arrow key by referencing the position setting information with the use of the direction indicated by the arrow key, when an input is made with the arrow key. Then, the execution control unit controls a display of the display panel based on selection range information indicating a display portion that is displayed on the display panel and corresponds to the characteristic range, and selection display information indicating how to display the display portion.

Additionally, when a display portion of the display panel, which corresponds to the currently selected characteristic range is selected by using an Enter key, the execution control unit generates decision information indicating that the display portion is selected, and controls execution of the application program based on the decision information.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 illustrates one implementation example of hardware of an information processing apparatus.

FIG. 2 illustrates one implementation example of an input/output unit.

FIG. 3 illustrates one implementation example of a control unit according to a first embodiment, and a relationship among the control unit, a storage unit and an input/output unit.

FIGS. 4A and 4B illustrate one implementation example of a display panel, and dots of an image displayed on the display panel.

FIGS. 5A, 5B, 5C, 5D and 5E illustrate one implementation example of characteristic extraction.

FIG. 6 illustrates one implementation example of an image displayed on the display panel, and results obtained by performing characteristic extraction from the image.

FIG. 7 is a flowchart illustrating one implementation example of operations of a position setting unit.

FIG. 8 illustrates one implementation example of data structures of selection range storage information and selection display information.

FIG. 9A is a flowchart illustrating one implementation example of operations of the execution control unit.

FIG. 9B is a flowchart illustrating one implementation example of the operations of the execution control unit.

FIG. 9C is a flowchart illustrating one implementation example of the operations of the execution control unit.

FIG. 10 illustrates one implementation example of a predetermined search.

FIG. 11 illustrates one implementation example of software according to the first embodiment.

FIG. 12A is a flowchart illustrating one implementation example of operations of an information processing apparatus according to a second embodiment.

FIG. 12B is a flowchart illustrating one implementation example of the operations of the information processing apparatus according to the second embodiment.

FIG. 12C is a flowchart illustrating one implementation example of the operations of the information processing apparatus according to the second embodiment.

### DESCRIPTION OF EMBODIMENTS

Embodiments are described in detail below with reference to the drawings.

A first embodiment is described.

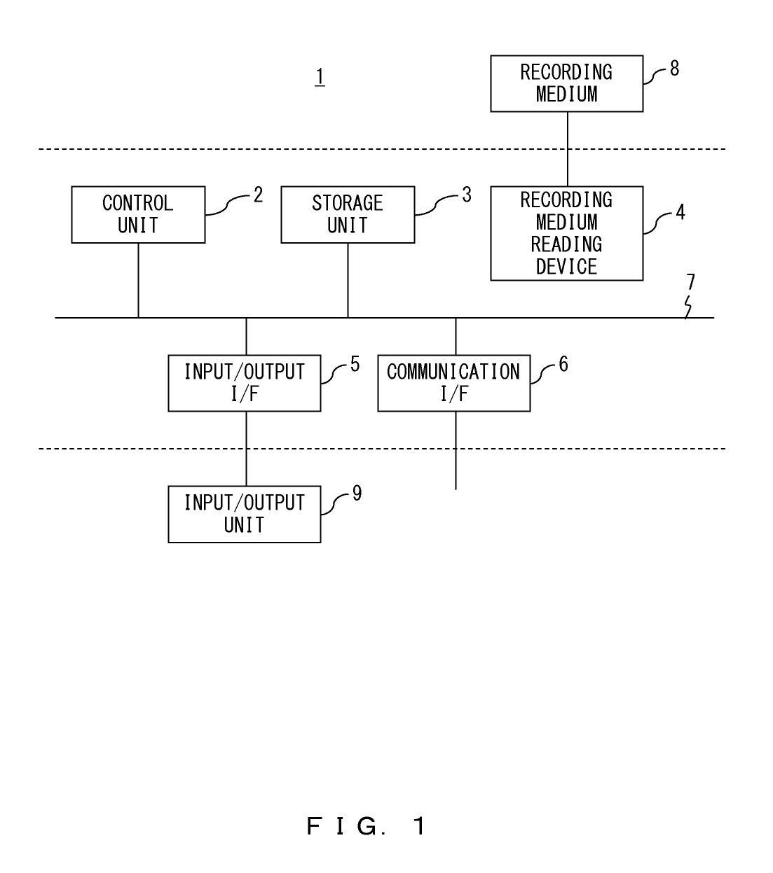

FIG. 1 illustrates one implementation example of hardware of an information processing apparatus. The information processing apparatus 1 illustrated in FIG. 1 includes a control unit 2, a storage unit 3, a recording medium reading device 4, an input/output interface (input/output I/F) 5, a communication interface (communication I/F) 6, and the like. These components are interconnected by a bus 7. Examples of the information processing apparatus 1 include a cellular phone, a PHS (Personal Handy-phone System), a smartphone, a portable information terminal, a personal computer and the like.

As the control unit 2, a CPU (Central Processing Unit), a multi-core CPU, a programmable device (an FPGA (Field Programmable Gate Array), a PLD (Programmable Logic Device) or the like) are available.

As the storage unit 3, a memory such as a ROM (Read Only Memory), a RAM (Random Access Memory) or the like, a hard disk and the like is available. Data such as parameter values, variable values and the like may be recorded in the storage unit 3. Alternatively, the storage unit 3 may be used as a working area at the time of execution.

The recording medium reading device 4 controls a data read/write from/to a recording medium 8 according to a control of the control unit 2. Data is written to the recording medium 8, or data recorded on the recording medium 8 is read according to the control of the recording medium reading device 4. Moreover, as an insertable/removable recording medium 8, a computer-readable non-transitory recording medium such as a magnetic recording device, an optical disc, a magneto-optical recording medium, a semiconductor memory or the like is available. Examples of the magnetic recording device include a hard disk device (HDD) and the like. Examples of the optical disc include a DVD (Digital Versatile Disc), a DVD-RAM, a CD-ROM (Compact Disc Read Only Memory), a CD-R (Recordable)/RW (ReWritable) and the like. Examples of the magneto-optical recording medium include an MO (Magneto-Optical disc) and the like. Also the storage unit 3 is one type of a non-transitory recording medium.

To the input/output interface 5, an input/output unit 9 is connected. The input/output interface 5 receives information input from the input/output unit 9, and transmits the information to the control unit 2 via the bus 7. Moreover, information and the like on displays a screen of a display panel (display unit) according to data transmitted from the control unit 2.

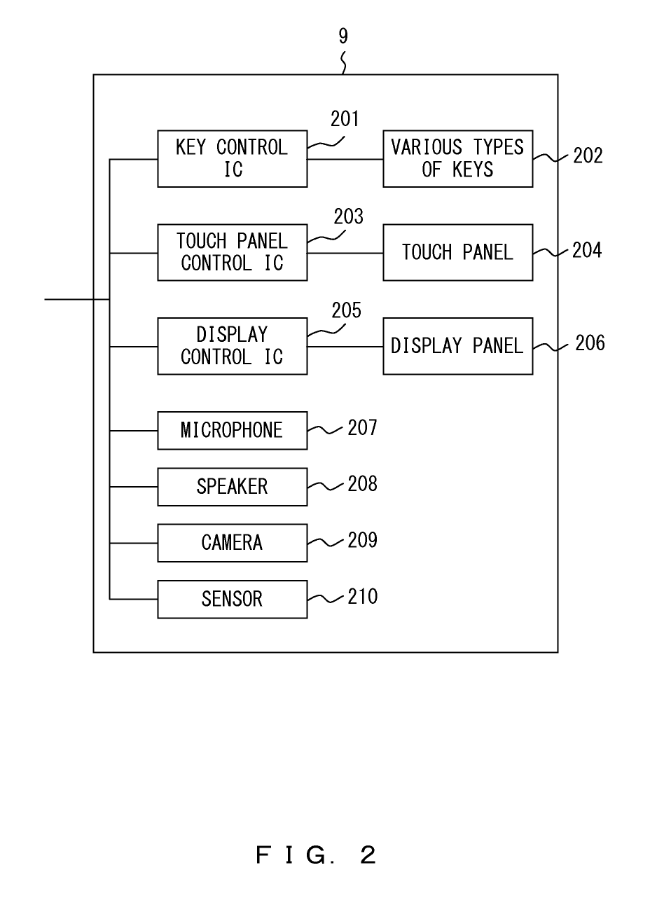

FIG. 2 illustrates one implementation example of the input/output unit. As the input/output unit 9 of FIG. 2, a key control IC (Integrated Circuit) 201, various types of keys 202, a touch panel control IC (Integrated Circuit) 203, a touch panel 204, a display control IC (Integrated Circuit) 205, a display panel 206, a microphone 207, a speaker 208, a camera 209, a sensor 210 and the like are available. As the display panel 206, for example, a liquid crystal display, an organic EL (ElectroLuminescence) display and the like are available.

However, the information processing apparatus 1 may be an information processing apparatus 1 that has neither the touch panel control IC 203 nor the touch panel 204, and supports only key inputs.

The key control IC 201 transmits information input with the various types of keys 202 to the control unit 2. The various types of keys 202 represent multi-function keys (MF keys) such as arrow keys, an Enter key or the like, and other input keys. The touch panel control IC 203 transmits information input with the touch panel 204 to the control unit 2. For example, an IC dedicated to a touch panel is available as the touch panel control IC 203. The display control IC 205 displays information on the display panel 206 according to data transmitted from the control unit 2. For example, an IC dedicated to a display panel is available.

The communication interface 6 is an interface for making a communication line connection, a LAN (Local Area Network) connection, an Internet connection, and a wireless connection. Moreover, the communication interface 6 is an interface for making a LAN connection, an Internet connection, or a wireless connection with another computer if needed.

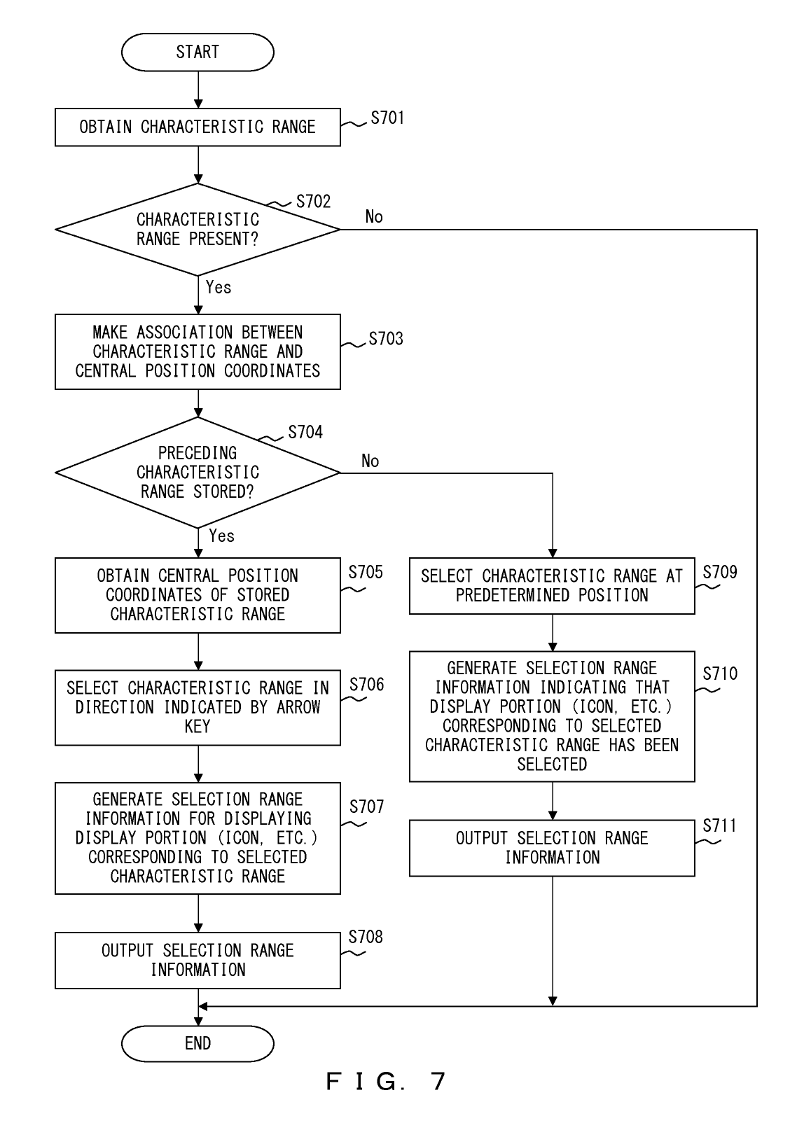

By using a computer having such a hardware configuration, various types of processing functions, to be described later, of the information processing apparatus are implemented. In this case, a program that describes processing contents of the functions to be possessed by the information processing apparatus is provided. A computer executes the program, whereby the processing functions (FIG. 7, 9A to 9C, 12A to 12C, and the like) to be described later are implemented by the computer. The program that describes the processing contents can be recorded on the computer-readable recording medium 8.

If the program is distributed, for example, the recording medium 8 such as a DVD, a CD-ROM or the like on which the program is recorded is marketed. Alternatively, the program can be recorded in a storage device of a server computer, and can be transferred from the server computer to another computer via a network.

The computer that executes the program stores, for example, the program recorded on the recording medium 8 or the program transferred from the server computer in the local storage unit 3. The computer reads the program from the local storage unit 3, and executes a process according to the program. Alternatively, the computer can read the program directly from the recording medium 8, and can execute a process according to the program. Still alternatively, the computer can execute a process according to a received program each time the program is transferred from the server computer.

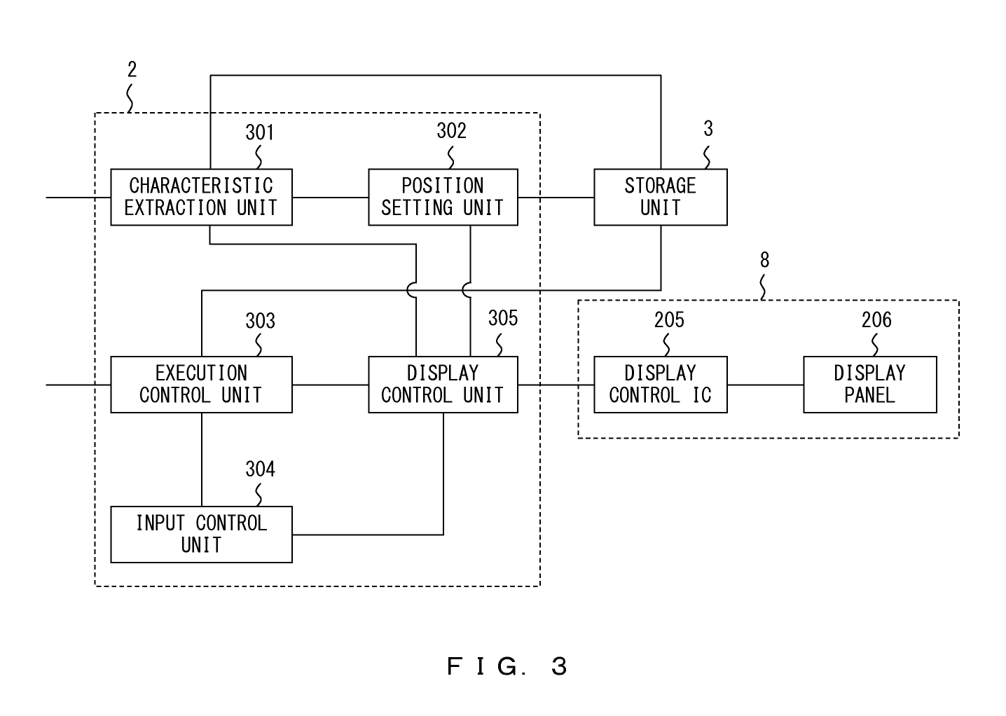

FIG. 3 illustrates one implementation example of the control unit according to the first embodiment, and a relationship among the control unit, the storage unit, and the input/output unit. In the control unit 2 of FIG. 3, a characteristic extraction unit 301, a position setting unit 302, an execution control unit 303, an input control unit 304, and a display control unit 305 are depicted. In the input/output unit 9 of FIG. 3, a display control IC 205 and a display panel 206 are depicted.

The characteristic extraction unit is described.

Upon receipt of an instruction of performing characteristic extraction, the characteristic extraction unit 301 obtains image data corresponding to an image displayed on the display panel 206 from the storage unit 3, extracts a characteristic from the displayed image by analyzing the image data, and decides a characteristic range by using the extracted characteristic. The characteristic range corresponds to a graphic displayed on the display panel.

A method of the characteristic extraction is described.

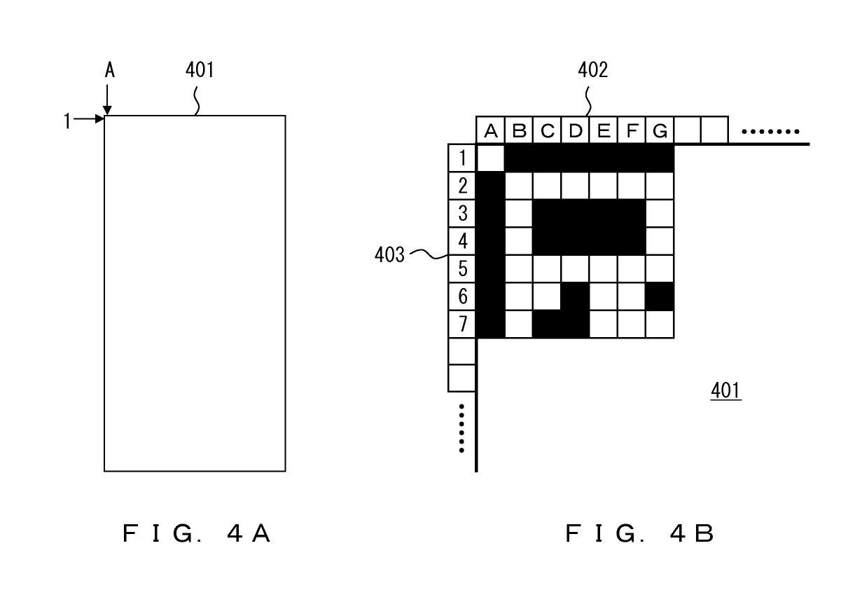

FIG. 4 illustrates one implementation example of the display panel, and dots of an image displayed on the display panel. The schematic illustrating the dots of the image in FIG. 4B depicts part of the display panel 401 of FIG. 4A. In this example, an arrow indicating a position of a coordinate A of a dot in a horizontal direction, and an arrow indicating a position of a coordinate 1 of the dot in a vertical direction are represented for the display panel 401 of FIG. 4A. FIG. 4B illustrates horizontal coordinates 402 representing coordinates A, B, C . . . in the horizontal direction, and vertical coordinates 403 representing coordinates 1, 2, 3 . . . in the vertical direction. The coordinate A of the dot in the horizontal direction and the coordinate 1 of the dot in the vertical direction, which are depicted on the display panel 401 of FIG. 4A, are the same as the coordinate A of the horizontal coordinate 402 and the coordinate 1 of the vertical coordinate 403 in FIG. 4B. Moreover, FIG. 4B illustrates the case where the dots of the image are represented in two colors (black and white). However, the colors are not limited to two colors.

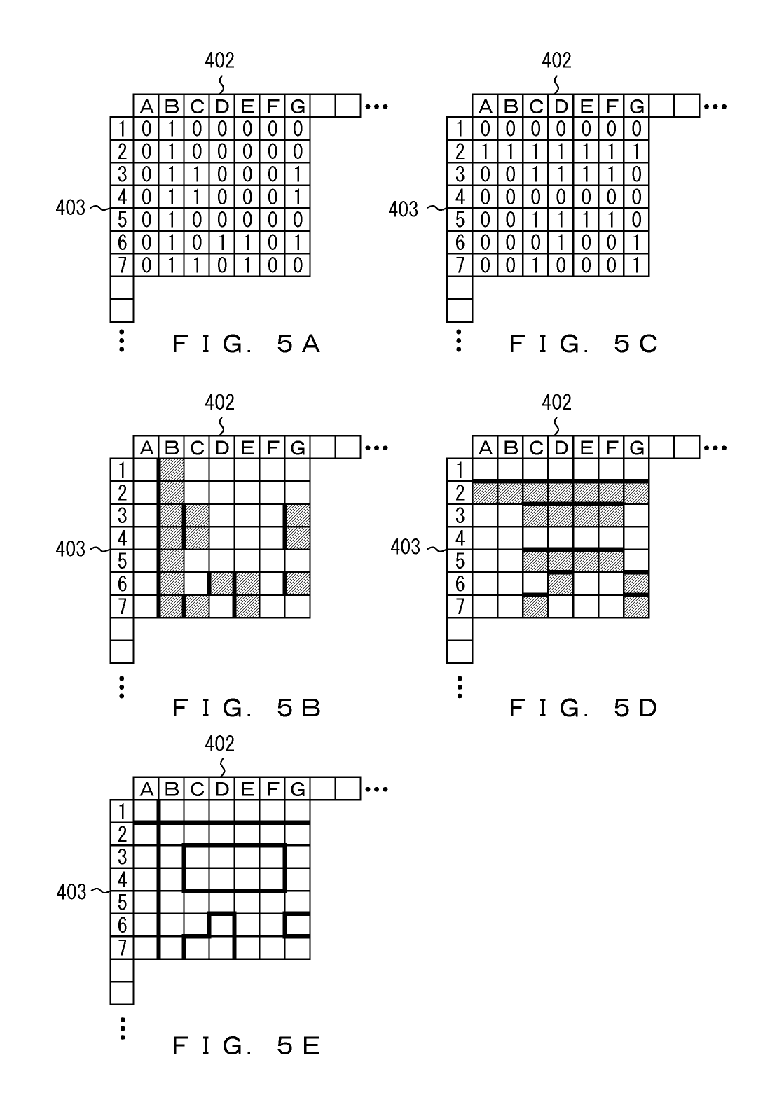

FIG. 5 illustrates one implementation example of the characteristic extraction process. The characteristic extraction unit 301 makes a comparison between pigment information of a target dot and that of a dot adjacent on the left side of the target dot. The characteristic extraction unit 301 sets the target dot to “1” if it has pigment information different from the adjacent dot, or sets the target dot to “0” if it has the same pigment information as the adjacent dot, so that the target dot is associated with “1” or “0”. In the example of FIG. 5A, since the dot indicated by the coordinates A1 does not have an adjacent dot on the left side, the dot is associated with “0”. The dot indicated by the coordinates B1 has an adjacent dot on the left side, which is indicated by the coordinates A1, and pigment information of dots respectively indicated by the coordinates B1 and the coordinates A1 are different. Therefore, the dot indicated by the coordinates B1 is associated with “1”. The dot indicated by the coordinates C1 has an adjacent dot indicated by the coordinates B1, and pigment information of the dots respectively indicated by the coordinates C1 and B1 are the same. Therefore, the dot indicated by the coordinates B1 is associated with “0”. In this example, the pigment information is information indicating black or white.

Next, the characteristic extraction unit 301 extracts a segment on the left side of a dot associated with “1”. FIG. 5B represents that segments (thick lines) on the left side of (shaded) dots associated with “1” are extracted. Information indicating positions of the extracted segments are stored in the storage unit 3.

Next, the characteristic extraction unit 301 makes a comparison between pigment information of a target dot and that of a dot adjacent on the upper side of the target dot. The characteristic extraction unit 301 sets a dot having different pigment information to “1”, and sets a dot having the same pigment information to “0”, so that the target dot is associated with “1” or “0”. In the example of FIG. 5C, since the dot indicated by the coordinates A1 does not have an adjacent dot on the upper side, it is associated with “0”. The dot indicated by the coordinates A2 has the adjacent dot indicated by the coordinates A1, and the pigment information of the dots respectively indicated by the coordinates A2 and A1 are different. Therefore, the dot indicated by the coordinates A2 is associated with “1”. The dot indicated by the coordinates A3 has the adjacent dot indicated by the coordinates A2, and the pigment information of the dots respectively indicated by the coordinates A3 and A2 are the same. Therefore, the dot indicated by the coordinates A3 is associated with “0”. In this example, the pigment information is information indicating black or white.

Next, the characteristic extraction unit 301 extracts a segment on the upper side of a dot associated with “1”. FIG. 5D represents that segments (thick lines) on the upper side of (shaded) dots associated with “1” are extracted. Information indicating positions of the extracted segments are stored in the storage unit 3. Then, the characteristic extraction unit 301 merges the segments on the left side and those on the upper side. In the example of FIG. 5E, a rectangle configured with the dots indicated by the coordinates C3, D3, E3, F3, C4, D4, E4 and F4 is represented by the merged segments. This rectangle is recognized as a characteristic range. If a rectangle obtained by merging segments does not have a certain width (horizontal width) and a certain height (vertical width), it may not be recognized as a characteristic range. The characteristic extraction may be performed with a method other than the above described one.

The position setting unit is described.

The position setting unit 302 makes a setting for making an association between a characteristic range and position coordinates of the display panel, which indicate a position of the characteristic range, and stores the characteristic range and the position coordinates in the storage unit 3. The association may be made between a characteristic range and coordinates of the touch panel.

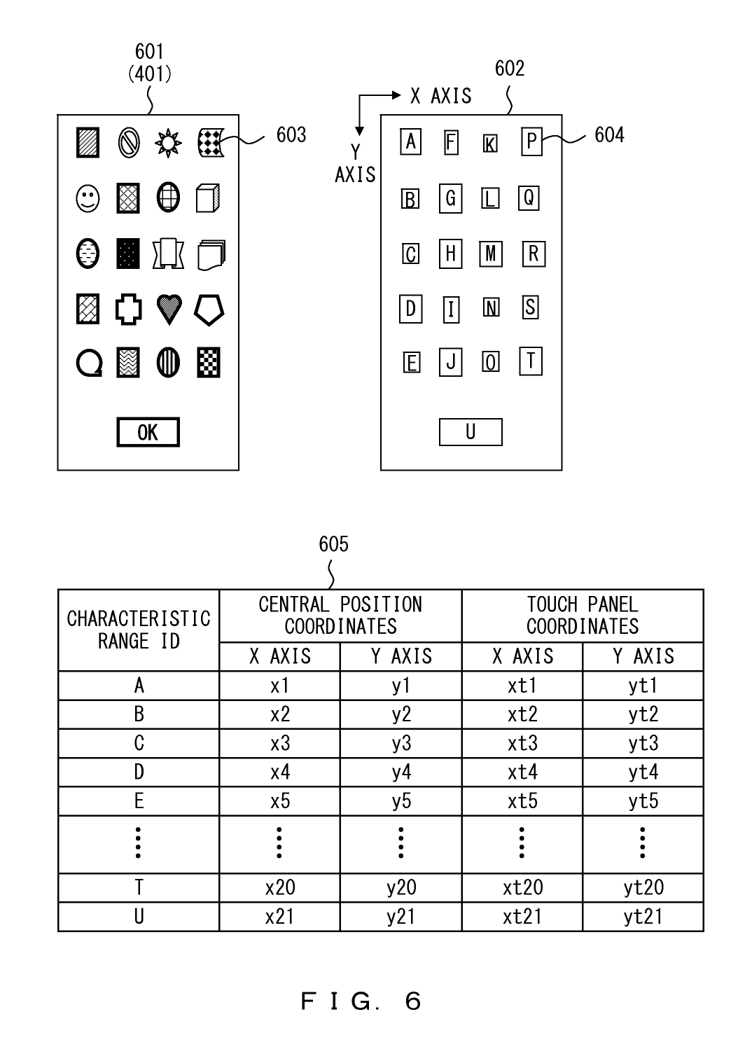

FIG. 6 illustrates one implementation example of an image displayed on the display panel, and results obtained by performing characteristic extraction from the image. On the display panel 601 illustrated in FIG. 6, 20 icons and one button (“OK”) are depicted. However, contents of the display are not limited to the display panel 601. In 602 of FIG. 6 illustrating the results obtained by performing characteristic extraction from the image displayed on the display panel 601, characteristic ranges A to T corresponding to the 20 icons are displayed, and a characteristic range U corresponding to the button is displayed. For example, the icon 603 corresponds to the characteristic range 604.

The position setting unit 302 makes, for example, characteristic ranges A to U of FIG. 6 correspond to position coordinates of the display panel, which indicate central position coordinates of the characteristic ranges A to U, and stores the characteristic ranges and the central position coordinates in the storage unit 3. FIG. 6 illustrates one implementation example of a data structure of position setting information. The position setting information 605 of FIG. 6 includes information stored in “characteristic range ID”, “central position coordinates”, and “touch panel coordinates”. In the “characteristic range ID”, information for identifying a characteristic range is stored. In this example, “A” to “U” for identifying the characteristic ranges A to U illustrated in FIG. 6 are stored. In the “central position coordinates”, information indicating coordinates of the display panel, which indicate the central position of a characteristic range, is stored. In this example, “x1” to “x21” respectively indicating the coordinate of the display panel in the X axis direction, which indicates the central position of each of the characteristic ranges A to U illustrated in FIG. 6, are stored. Moreover, “y1” to “y21” respectively indicating the coordinate of the display panel in the Y axis direction, which indicates the central position of each of the characteristic ranges A to U illustrated in FIG. 6, are stored. In the “touch panel coordinates”, information indicating the position coordinates of the touch panel, which correspond to the central position coordinates, is stored. In this example, “xt1” to “xt21” respectively indicating the coordinate of the touch panel in the X axis direction of each of the characteristic ranges A to U illustrated in FIG. 6 are stored. Moreover, “yt1” to “yt21” respectively indicating the coordinate of the touch panel in the Y axis direction of each of the characteristic ranges A to U illustrated in FIG. 6 are stored.

However, if a characteristic range is initially selected after the information processing apparatus has been powered up, the position setting unit 302 selects, for example, a characteristic range close to the upper left corner of the display panel. In the case of 602 in FIG. 6, the characteristic range A is initially selected after the information processing apparatus has been powered up. However, a characteristic range selected after the information processing apparatus has been powered up is not limited to the characteristic range at the upper left corner of the display panel.

Operations of the position setting unit are described.

FIG. 7 is a flowchart illustrating one implementation example of the operations of the position setting unit. In step S701, the position setting unit 302 obtains a characteristic range that is extracted by the characteristic extraction unit 301 and stored in the storage unit 3 upon termination of the characteristic extraction process.

In step S702, the position setting unit 302 determines whether or not a characteristic range settable as a selection range is present. When the characteristic range settable as a selection range is present (“YES” in step S702), the flow goes to step S703. When the characteristic range settable as a selection range is not present (“NO” in step S702), the process of the position setting unit is terminated. The case where the characteristic range settable as a selection range is present is a case where a characteristic range is extracted from an image currently displayed on the display panel. The case where the characteristic range settable as a selection range is not present is a case where a characteristic range is not extracted from the image currently displayed on the display panel.

In step S703, the position setting unit 302 generates position setting information by making an association between the characteristic range extracted by the characteristic extraction unit 301 and central position coordinates of the characteristic range, and stores the generated information in the storage unit 3. Alternatively, an association may be made between a characteristic range and touch panel coordinates corresponding to the central position coordinates. See the position setting information 605 of FIG. 6.

In step S704, the position setting unit 302 determines whether or not the preceding characteristic range is stored. When the preceding characteristic range is stored (“YES” in step S704), the flow goes to step S705. When the preceding characteristic range is not stored (“NO” in step S704), the flow goes to step S709. The case where the preceding characteristic range is not stored is, for example, a case of the initial process executed after the information processing apparatus has been powered up.

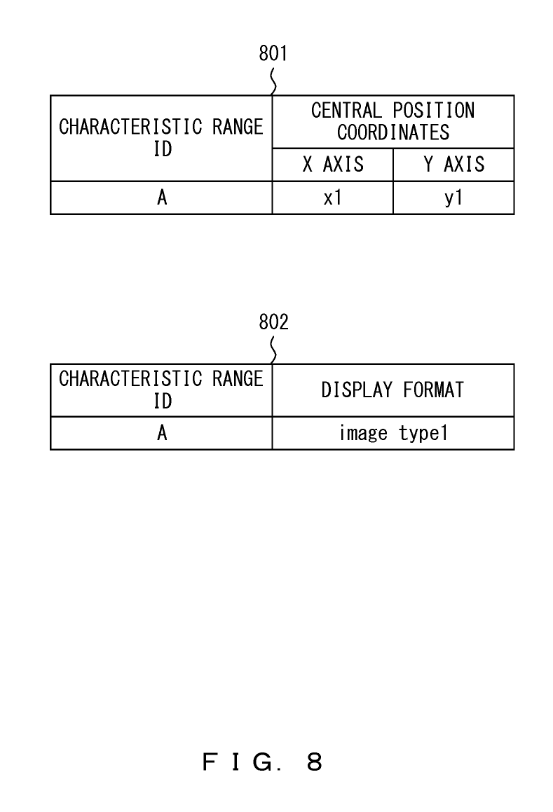

In step S705, the position setting unit 302 obtains, from the storage unit 3, a characteristic range selected before the characteristic extraction is performed, and central position coordinates corresponding to the characteristic range. For example, each time a characteristic range is changed, an association is made between the characteristic range and central position coordinates corresponding to the characteristic range, and the characteristic range and the central position coordinates are stored as the selection range storage information in the storage unit 3. FIG. 8 illustrates one implementation example of data structures of the selection range storage information and the selection display information. The selection range storage information 801 of FIG. 8 includes information stored in “characteristic range ID” and “central position coordinates”. In the “characteristic range ID”, information for identifying a characteristic range is stored. In this example, “A” for identifying the characteristic range A illustrated in FIG. 6 is stored. In the “central position coordinates”, information indicating coordinates of the display panel, which indicate the central position of a characteristic range, is stored. In this example, “x1” indicating the coordinate of the display panel in the X axis direction, which indicates the central position of the characteristic range A illustrated in FIG. 6, is stored. Additionally, “y1” indicating the coordinate of the display panel in the Y axis direction, which indicates the central position of the characteristic range A illustrated in FIG. 6, is stored.

In step S706, the position setting unit 302 selects a characteristic range in a direction indicated by an arrow key included in operation information by referencing the position setting information. For example, information about the characteristic range A illustrated in 602 of FIG. 6 is stored as the selection range storage information. When the arrow key is a right arrow key, the characteristic range F, and information associated with the characteristic range F are selected. Note that the process of step S706 may be omissible.

In step S707, the position setting unit 302 generates selection range information for displaying a display portion (such as an icon, a button or the like) corresponding to the characteristic range selected in step S705 or step S706.

In step S708, the position setting unit 302 outputs the selection range information to the display control unit 305. The position setting unit 302 also outputs selection display information to the display control unit 305. The selection display information 802 of FIG. 8 includes information stored in “characteristic range ID” and “display format”. In the “characteristic range ID”, information for identifying a characteristic range is stored. In this example, “A” for identifying the characteristic range “A” illustrated in FIG. 6 is stored. In the “display format”, information for adding an effect recognizable by a user to the display is stored. In this example, “image type 1” is stored as information for changing a color of the display, for inverting the display, and for displaying segments enclosing the display on the display panel 206 by using the display control unit 305.

In step S709, the position setting unit 302 selects a characteristic range at a specified position. For example, the position setting unit 302 detects central position coordinates of a characteristic range close to position coordinates of the upper left corner of the display panel, which are stored in the storage unit 3 as the specified position, by referencing the position setting information, and selects a characteristic range corresponding to the central position coordinates close to the position coordinates of the upper left corner. In the case of 602 in FIG. 6, the characteristic range A is initially selected after the information processing apparatus has been powered up. However, a characteristic range selected after the information processing apparatus has been powered up is not limited to that at the upper left corner of the display panel.

In step S710, the position setting unit 302 generates selection range information indicating that a display portion (such as an icon, a button or the like) corresponding to the characteristic range selected in step S709 has been selected.

In step S711, the position setting unit 302 outputs the selection range information to the display control unit 305. The position setting unit 302 also outputs the selection display information to the display control unit 305.

The execution control unit is described.

The execution control unit 303 obtains operation information corresponding to each of operations of MF keys input when an MF key (an arrow key, an Enter key or the like) of the information processing apparatus 1 is selected. Then, the execution control unit 303 determines whether or not an arrow key among the MF keys is selected by using the obtained operation information. When the arrow key is selected, the execution control unit 303 selects a characteristic range present in a direction indicated by the arrow key with the use of the currently selected characteristic range, and the direction indicated by the arrow key in the operation information.

For example, the execution control unit 303 obtains, from the storage unit 3, a characteristic range selected before the characteristic extraction is performed, and central position coordinates corresponding to the characteristic range. The execution control unit 303 also obtains operation information corresponding to each of the operations of the MF keys input when an MF key (an arrow key, the Enter key or the like) of the information processing apparatus 1 is selected. Then, the execution control unit 303 detects the next characteristic range by referencing the position setting information with the use of the characteristic range selected before the characteristic extraction is performed, and the obtained operation information. After detecting the next characteristic range, the execution control unit 303 generates selection range information indicating that a display portion (such as an icon, a button or the like) corresponding to the detected characteristic range has been selected.

Additionally, the execution control unit 303 generates selection display information for adding, to the display, an effect by which a user can recognize that the display portion (such as an icon, a button or the like) corresponding to the display range is currently being selected. As the selection display information, for example, information for changing a color of the display, for inverting the display, and for displaying segments enclosing the display on the display panel 206 are available. Moreover, the position setting unit 302 transmits the selection range information and the selection display information to the display control unit 305.

However, when a characteristic range is not present in a direction indicated by the arrow key, a predetermined search to be described later is performed.

Alternatively, when the Enter key among the MF keys is selected, the execution control unit 303 transmits decision information to select to execute the display of the display panel, which corresponds to the currently selected characteristic range, to the input control unit 304. Namely, the decision information is the same as information for executing an application corresponding to a selected icon when the icon or the like displayed on the display panel is selected (touched) with the touch panel.

Additionally, when the direction indicated by the arrow key included in the received operation information indicates an outside of the display panel at an end of the display panel on which the currently selected characteristic range is being displayed, display range information for displaying another screen by scrolling the currently displayed screen is generated. The display range information is, for example, information corresponding to an event of scrolling the display screen with a finger when the touch panel is operated. This display range information is transmitted to the input control unit 304.

Furthermore, a move of a characteristic range and a page scroll may be assigned to a double click or the like of an arrow key when the Web is browsed.

Note that information corresponding to an operation input with a key other than the MF keys is made to correspond to an operation of the touch panel. For example, information input with a numeric key, a character input key or the like is converted into information utilized when the touch panel is used. Information corresponding to an operation performed with a key other than the MF keys is input to the input control unit 304 via the execution control unit 303. Moreover, if the same information as that utilized when the touch panel is used is applied as the information corresponding to an operation performed with a key other than the MF keys, the information may be input to the input control unit 304 not via the execution control unit 303.

Operations of the execution control unit are described.

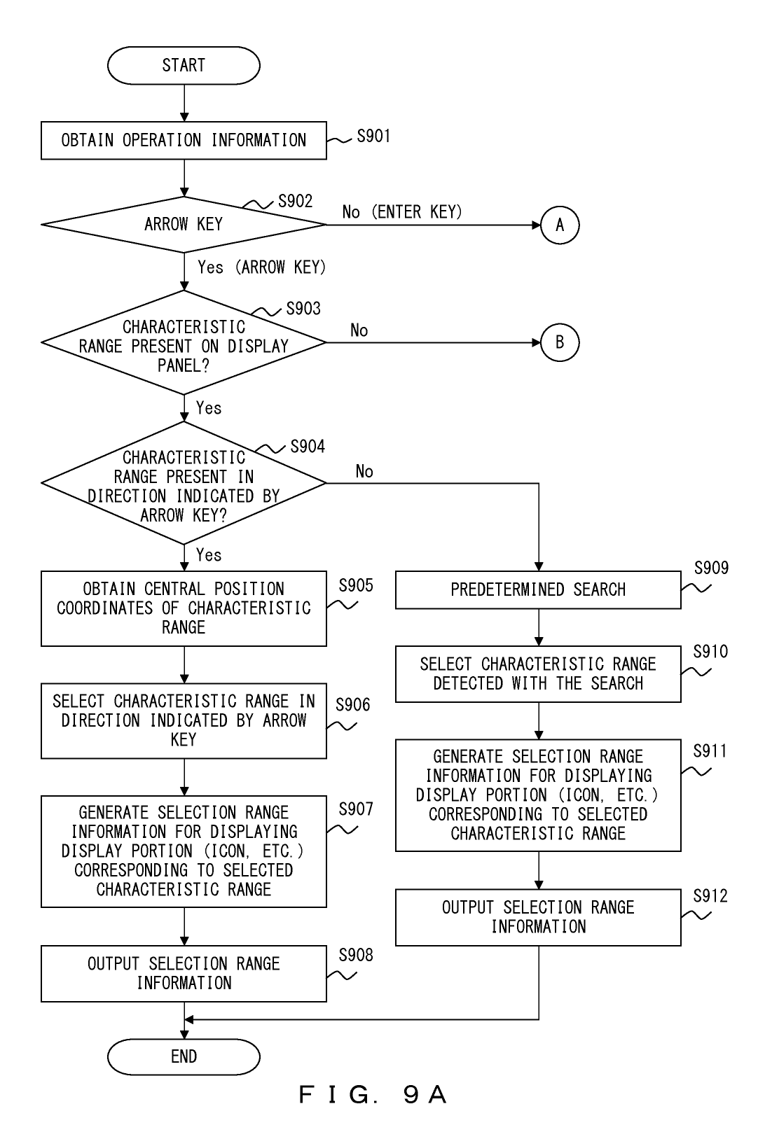

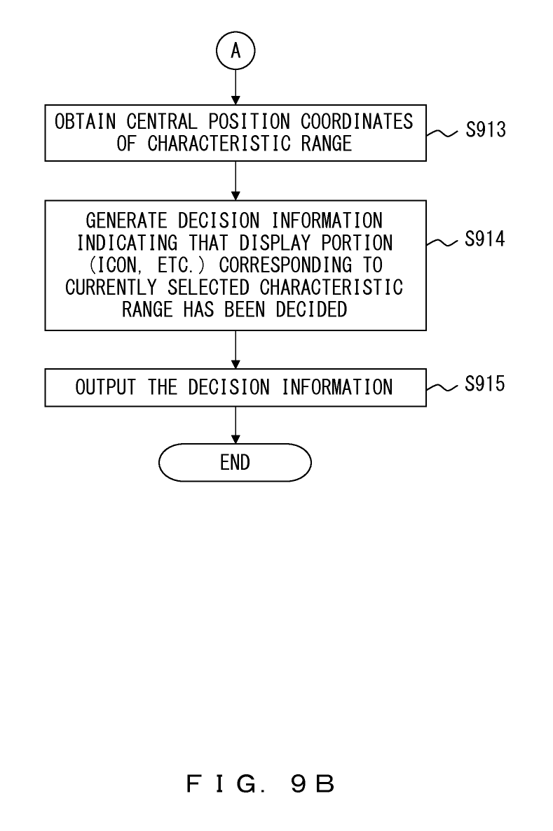

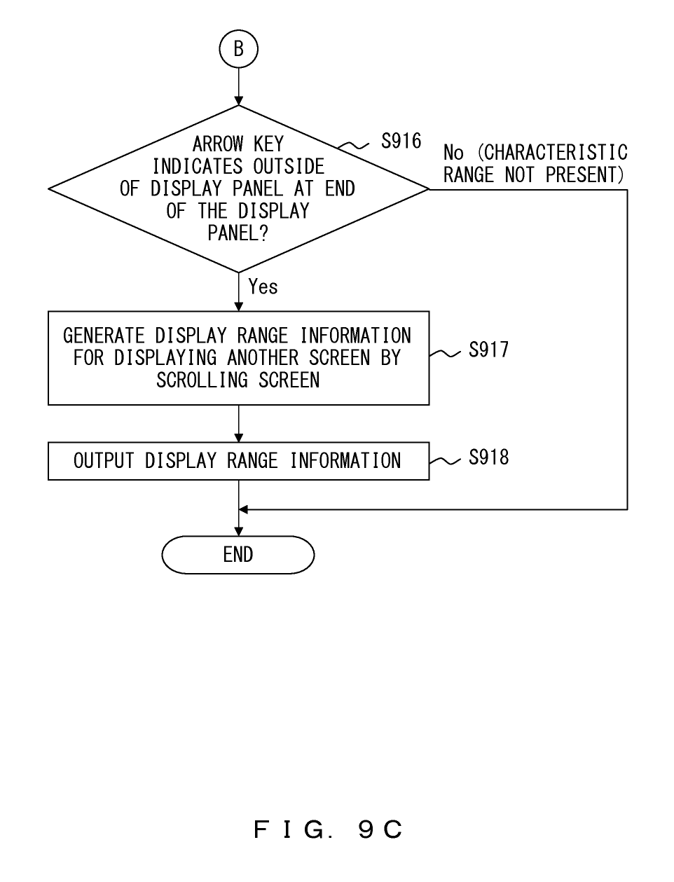

FIGS. 9A to 9C are flowcharts illustrating one implementation example of the operations of the execution control unit. In step S901, the execution control unit 303 obtains operation information that is input when an MF Key (an arrow key, the Enter key or the like) of the information processing apparatus 1 is selected, and corresponds to each of operations of the MF keys.

In step S902, the execution control unit 303 determines whether or not the selected MF key is an arrow key by referencing the operation information. When the selected MF key is the arrow key (“YES” in step S902), the flow goes to step S903. Alternatively, when the input key is the Enter key (“NO” in step S902), the flow goes to step S913.

In step S903, the execution control unit 303 determines whether or not a characteristic range settable as a selection range is present by referencing position setting information corresponding to the image currently displayed on the display panel. When the characteristic range settable as a selection range is present (“YES” in step S903), the flow goes to step S904. When the characteristic range settable as the selection range is not present (“NO” in step S903), the flow goes to step S916.

In step S904, the execution control unit 303 determines whether or not another characteristic range is present in a direction indicated by an arrow key from the currently selected characteristic range by referencing the direction indicated by the arrow key included in the operation information, and the position setting information. When another characteristic range is present in the direction indicated by the arrow key (“YES” in step S904), the flow goes to step S905. Alternatively, when another characteristic range is not present in the direction indicated by the arrow key (“NO” in step S904), the flow goes to step S909. The case where another characteristic range is not present in the direction indicated by the arrow key is, for example, a case where another characteristic range is not present in upward, downward, right and left directions of the currently selected characteristic range.

In step S905, the execution control unit 303 obtains central position coordinates of the currently selected characteristic range by referencing the position setting information.

In step S906, the execution control unit 303 selects the characteristic range indicated by the arrow key with the use of the central position coordinates of the characteristic range, which has been obtained in step S905, and the direction indicated by the arrow key.

In step S907, the execution control unit 303 generates selection range information indicating that a display portion (such as an icon, a button or the like) corresponding to the characteristic range selected in step S906 has been selected.

In steps S905 to S907, for example, when an arrow key among the MF keys is selected, a characteristic range (central position coordinates or the like) to be selected next is detected by referencing the position setting information stored in the storage unit 3 with the use of information indicating the arrow key, which is included in the operation information.

For example, upon receipt of operation information indicating that the right arrow key among the arrow keys is selected when the characteristic range A in 602 of FIG. 6 is currently being selected, a characteristic range F positioned in the right direction of the characteristic range A is detected by referencing the position setting information 605 with the use of the operation information. Alternatively, upon receipt of operation information indicating that the left arrow key among the arrow keys is selected when the characteristic range K in 602 of FIG. 6 is currently being selected, the characteristic range F positioned in the left direction of the characteristic range K is detected by referencing the position setting information 605 with the use of the operation information. Still alternatively, upon receipt of operation information indicating that the up arrow key among the arrow keys is selected when the characteristic range J in 602 of FIG. 6 is currently being selected, the characteristic range I positioned in the upward direction of the characteristic range J is detected by referencing the position setting information 605 with the use of the operation information. Still alternatively, upon receipt of operation information indicating that the down arrow key among the arrow keys is selected when the characteristic range I in 602 of FIG. 6 is currently being selected, the characteristic range J positioned in the downward direction of the characteristic range I is detected by referencing the position setting information 605 with the use of the operation information.

In step S908, the execution control unit 303 outputs the selection range information to the display control unit 305. The execution control unit 303 also outputs selection display information to the display control unit 305.

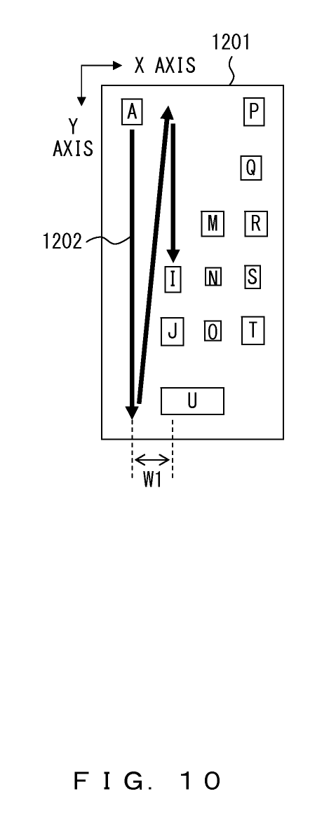

In step S909, the execution control unit 303 makes a predetermined search. Namely, when a characteristic range is not present in a direction indicated by an arrow key included in received operation information when selecting the next characteristic range from the currently selected characteristic range, the execution control unit 303 detects the characteristic range by referencing position setting information in a predetermined order. The predetermined search is described. FIG. 10 illustrates one implementation example of the predetermined search. When the down arrow key is selected when a characteristic range A in 1201 of FIG. 10 is being selected, no characteristic range is present in the downward direction, and a characteristic range to be selected cannot be detected. Accordingly, when a characteristic range cannot be detected although the execution control unit 303 searches for a characteristic range in the downward direction up to the bottom end of the display panel 1201, the execution control unit 303 searches for a characteristic range in the downward direction from the top end of the display panel 1201, which is separate by a predetermined width W1, as indicated by an arrow 1202 of FIG. 10. The execution control unit searches for a characteristic range by repeating this operation. In this example, a characteristic range I is detected. The search is made as described above in this example. However, the predetermined search is not limited.

In step S910, the execution control unit 303 selects the characteristic range detected with the search. In step S911, the execution control unit 303 generates selection range information indicating that a display portion (such as an icon, a button or the like) corresponding to the characteristic range selected in step S910 has been selected.

In step S912, the execution control unit 303 outputs the selection range information to the display control unit 305. The execution control unit 303 also outputs the selection display information to the display control unit 305.

In step S913, the execution control unit 303 obtains central position coordinates of the currently selected characteristic range by referencing position setting information.

In step S914, the execution control unit 303 generates decision information indicating that a display portion (such as an icon, a button or the like) corresponding to the characteristic range selected in step S913 has been selected and decided.

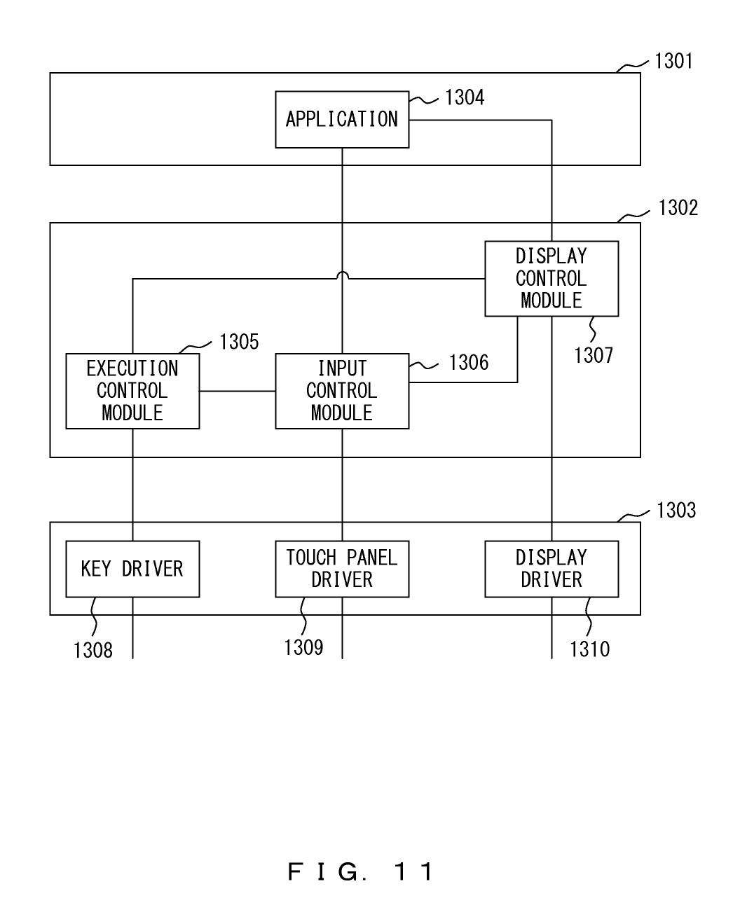

In step S915, the execution control unit 303 outputs, to the input control unit 304, the decision information indicating that the currently selected characteristic range has been decided. Note that the decision information is also input to application software that is being executed and employs the touch panel as a user interface. See FIG. 11 to be described later.

FIG. 11 illustrates one implementation example of software according to the first embodiment. The software according to the first embodiment illustrated in FIG. 11 is stored in the storage unit 3, and executed by the control unit 2. The software according to the first embodiment includes, for example, an application software layer 1301, an application framework layer 1302, a driver layer 1303 and the like.

The application software layer 1301 includes one or more pieces of application software 1304 employing the touch panel as a user interface.

The application framework layer 1302 includes an execution control module 1305, an input control module 1306, a display control module 1307 and the like. The execution control module 1305 has functions of the above described execution control unit 303. The input control module 1306 has functions of the above described input control unit 304. The display control module 1307 has functions of the above described display control unit 305, receives information about a display from the application software 1304, the execution control module 1305, the input control module 1306 and the like, and controls the display panel by using the received information.

The driver layer 1303 includes a key driver 1308, a touch panel driver 1309, a display driver 1310 and the like. The key driver 1308 obtains information about a key operation input from the key control IC 201, and inputs the obtained information to the application framework layer 1302. The touch panel driver 1309 obtains information about a touch panel operation input from the touch panel control IC 203, and inputs the obtained information to the application framework layer 1302. The touch panel driver 1309 may not be provided. The display driver 1310 obtains information about a display on the display panel, which is input from the display control IC 205, and inputs the obtained information to the application framework layer 1302.

When a currently selected characteristic range is positioned at an end of the display panel and an arrow key is orientated outside the display panel in step S916 (“YES” in step S916), the flow goes to step S917. When no characteristic range is present on the currently displayed display panel (“NO” in step S916), the process is terminated.

In step S917, the execution control unit 303 generates display range information for displaying another screen by scrolling the screen. For example, if the left arrow key is selected when any one of the characteristic ranges A, B, C, and E at the end of the display panel is selected in 602 of FIG. 6, the execution control unit 303 transmits, to the input control unit 304, information for displaying another screen by scrolling the currently displayed screen to the right. Alternatively, when the right arrow key is selected when any one of the characteristic ranges P, Q, R, S, and T at the end of the display panel in 602 of FIG. 6 is selected, the execution control unit 303 transmits, to the input control unit 304, information for displaying another screen by scrolling the currently displayed screen to the left. Still alternatively, if the up arrow key is selected when any one of the characteristic ranges A, F, K, and P at the end of the display panel in 602 of FIG. 6 is selected, the execution control unit 303 transmits, to the input control unit 304, information for displaying another screen by scrolling the currently displayed screen downward. Still alternatively, if the down arrow key is selected when any one of the characteristic ranges E, U and T at the end of the display panel in 602 of FIG. 6 is selected, the execution control unit 303 transmits, to the input control unit 304, information for displaying another screen by scrolling the currently displayed screen upward.

In step S918, the execution control unit 303 outputs the display range information to the input control unit 304.

The input control unit is described.

The input control unit 304 receives decision information, display range information and the like, which are generated by the execution control unit 303. Moreover, the input control unit 304 inputs received decision information to an application program, and transmits the display range information to the display control unit 305. The decision information may be transmitted to the display control unit 305, which is used to make a display indicating that the information has been decided.

An operation that the input control unit 304 performs upon receipt of the decision information is described. For example, when the received decision information indicates an icon of an application, which corresponds to the central position coordinates of the currently selected characteristic range, the input control unit 304 transmits, to the display control unit 305, information indicating that the application corresponding to the icon is to be executed. This example refers to the case where the decision information indicates the icon. However, the decision information may indicate a button (U of FIG. 6) or the like.

The display control unit is described.

The display control unit 305 receives information transmitted from the execution control unit 303 or the input control unit 304, generates information for executing a process corresponding to an operation of the touch panel by using the received information, and transmits the generated information to the display control IC 205. Moreover, the display control unit 305 uses a selection range layer to select a display portion (such as an icon, a button or the like) in an image on the display panel, which is associated with selection range information, and separates the image into the selection range layer and an image synthesis layer used to display the original image on the display panel. Namely, the display control unit 305 executes a process for superimposing the selection range layer on the image synthesis layer. This eliminates the need for modifying the original image on the display panel. Moreover, an image process for rewriting a difference to an original image created by an application program is sometimes executed. Therefore, it is desirable to superimpose a display indicating that a corresponding display portion has been selected on the selected display portion (such as an icon, a button or the like) after the original image has been generated.

According to the first embodiment, an effect is produced such that even an application program employing a touch panel as a user interface can be operated with an MF key without adding a process corresponding to an operation of the MF key such as an arrow key, an Enter key or the like to the application program.

A second embodiment is described.

According to the second embodiment, if no operation is performed for a predetermined duration, a display indicating a selection range of the currently selected display is made invisible (the selection range is made invisible) in addition to the operations of the first embodiment. Namely, when no input is made with a key for the predetermined duration, it is recognized that no operation is performed (for example, the screen is left unchanged), and the selection range is made invisible, leading to reductions in power consumption.

Additionally, while a screen displayed on the display panel is being updated after the currently selected display portion (such as an icon, a button or the like) has been decided, an input with an MF key is invalidated.

Operations of an information processing apparatus according to the second embodiment are described.

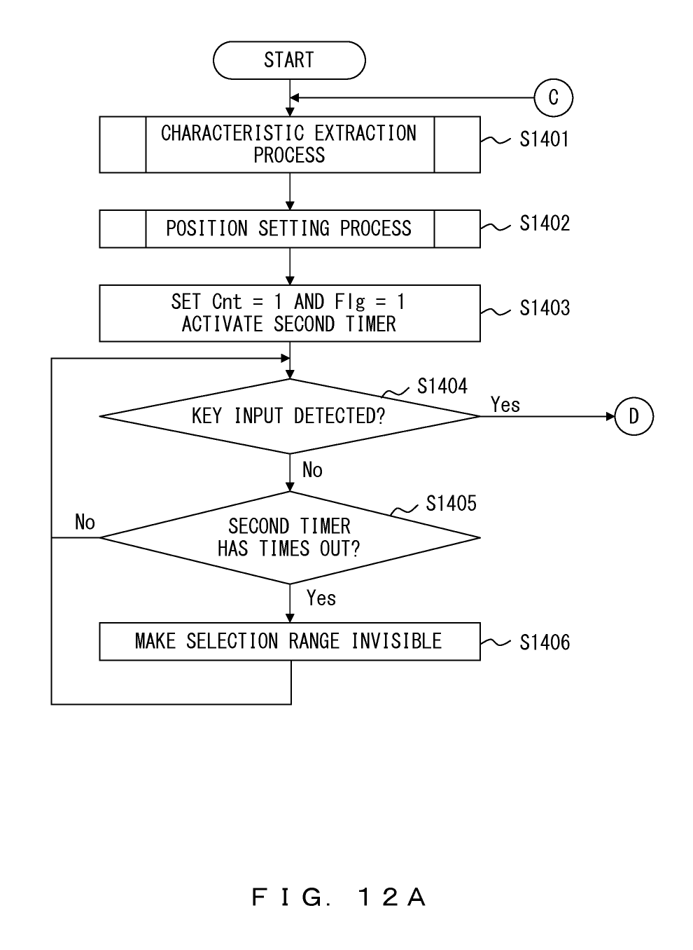

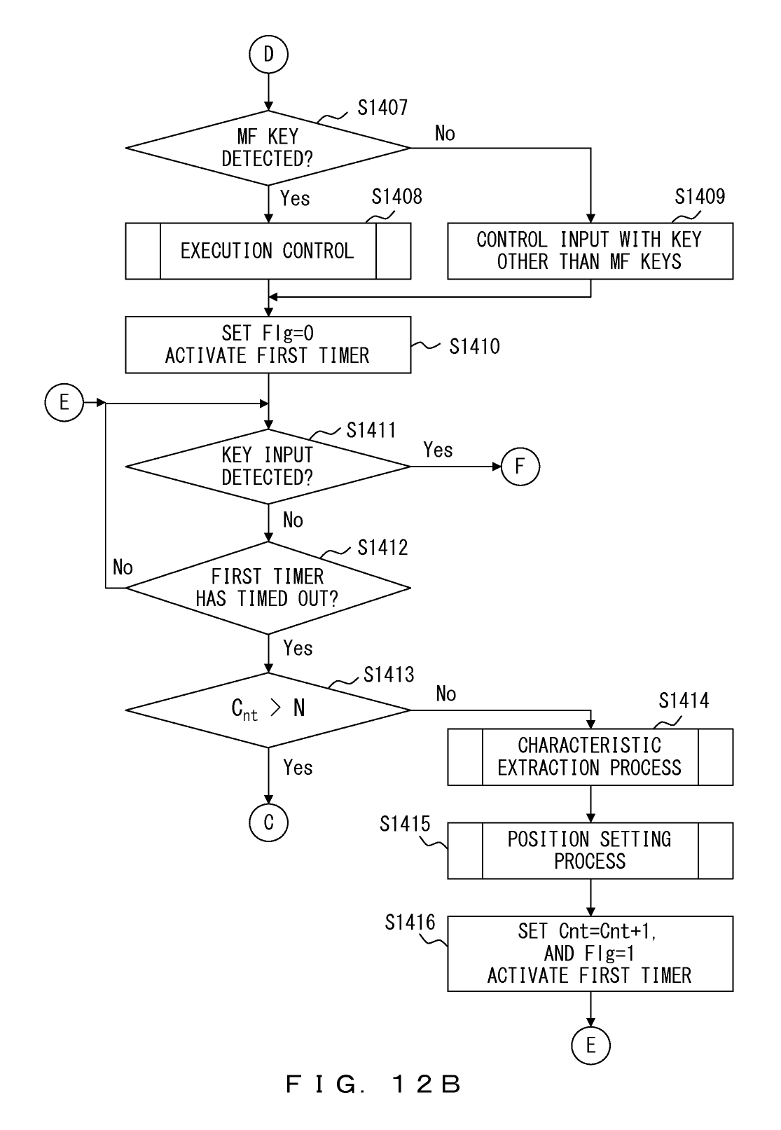

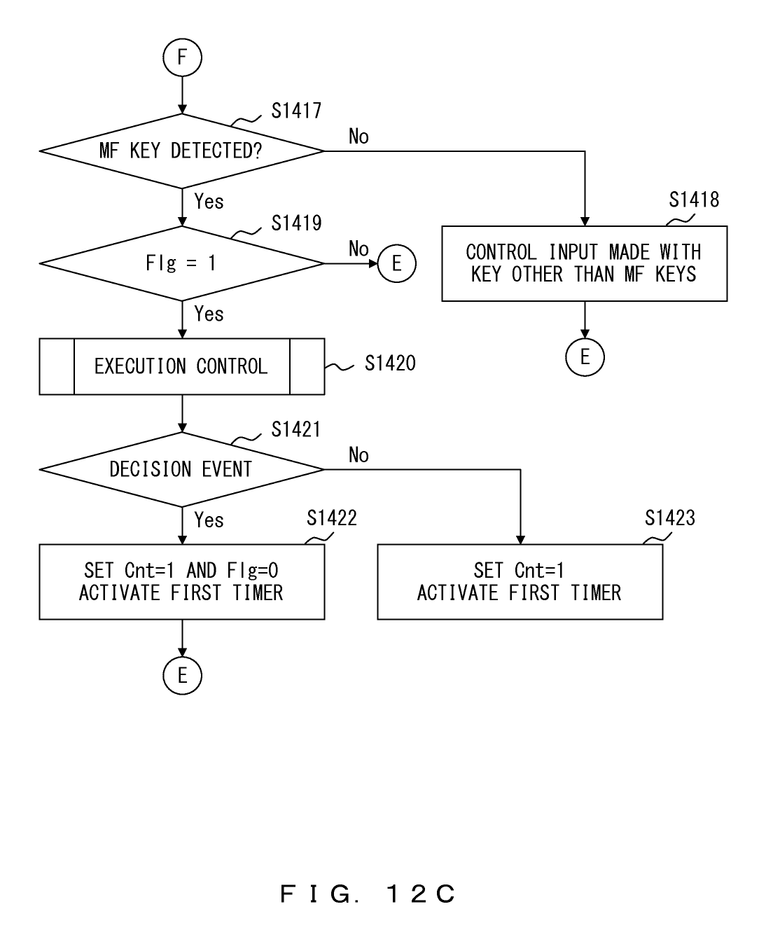

FIGS. 12A to 12C are flowcharts illustrating one implementation example of the operations of the information processing apparatus according to the second embodiment. The information processing apparatus 1 has been powered up, and an image is displayed on its display panel. In step S1401 (characteristic extraction process), the characteristic extraction unit 301 executes a characteristic extraction process for the image currently displayed on the display panel.

In step S1402 (position setting process), the position setting unit 302 generates position setting information by making an association among a characteristic range extracted in step S1, central position coordinates of the characteristic range, and coordinates of the touch panel, and stores the generated information in the storage unit 3. For example, see the position setting information 605 of FIG. 6. Additionally, in the initial step after the information processing apparatus has been powered up, a characteristic range that is close to predetermined position coordinates and stored in the storage unit 3 is selected.

In step S1403, the display control unit 305 sets, to 1, a variable “Cnt” indicating the number of times that the characteristic extraction is performed (Cnt=1). The display control unit 305 also sets a flag “Flg”, which indicates whether or not the characteristic extraction has been performed, to 1 indicating that the characteristic extraction has been performed (Flg=1). Moreover, the display control unit 305 activates a second timer for measuring a specified time.

In step S1404, the display control unit 305 detects whether or not an input has been made to the control unit 2 with any of the various types of keys 202. When the input has been made with any off the various types of keys (“YES” in step S1404), the flow goes to step S1407. When the input has not been made with any of the various types of keys (“NO” in step S1404), the flow goes to step S1405.

When the second timer has timed out in step S1405 (“YES” in step S1405), the flow goes to step S1406. When the second timer does not time out (“NO” in step S1405), the flow goes to step S1404.

In step S1406, the display control unit 305 makes the display indicating the selection range of the currently selected display invisible (makes the selection range invisible). Namely, When no input is made with a key for a predetermined duration, it is recognized that no operation is performed (for example, the screen is left unchanged), and the selection range is made invisible, leading to reductions in power consumption.

When the control unit 2 (or the execution control unit 303) detects that an input has been made with an MF key in step S1407 (“YES” in step S1407), the flow goes to step S1408. When the control unit 2 detects that the input has been made with a key other than the MF keys (“NO” in step S1407), the flow goes to step S1409.

In step S1408, the execution control unit 303 executes the execution control process. In step S1409, the execution control unit 303 controls an input made with a key other than the MF keys. Information input with, for example, a numeric key, a character input key or the like is converted into information utilized when the touch panel is used. Information corresponding to an operation performed with a key other than the MF keys is input to the input control unit 304 via the execution control unit 303.

In step S1410, the display control unit 305 sets the flag Flg to “0” indicating that the characteristic extraction is not performed (Flg=0). The reason for setting Flg=0 is that the characteristic extraction is to be again performed due to a possibility that an image displayed on the display panel can be changed by the processes in steps S1407 to S1409. Moreover, the display control unit 305 activates a first timer for deciding an interval of performing the characteristic extraction.

In steps S1411 to S1423, while the screen is being updated with an application after a display portion (such as an icon, a button or the like) corresponding to the currently selected characteristic range has been decided with the Enter key, an input with an MF key is invalidated. For example, if MF keys are sequentially pressed, the screen is prevented from being meaninglessly updated by the application by invalidating an input of an MF key.

In step S1411, the display control unit 305 detects whether or not an input has been made with any of the various types of keys 202. When the input has been made with any of the various types of keys (“YES” in step S1411), the flow goes to step S1417. When the input has not been made (“NO” in step S1411), the flow goes to step S1412.

When the first timer has timed out in step S1412 (“YES” in step S1412), the flow goes to step S1413. When the first timer does not time out (“NO” in step S1412), the flow goes back to step S1411.

If the variable Cnt indicating the number of times that the characteristic extraction is performed is larger than a threshold value N (Cnt>N) in step S1413 (“YES” in step S1413), the flow goes back to step S1401. If the variable Cnt is equal to or smaller than the threshold value N (“NO” in step S1413), the flow goes to step S1414.

When the number of times that the characteristic extraction is performed exceeds the threshold value N after the first timer has timed out, the flow goes back to step S1401. Then, the display indicating the selection range of the currently selected display is made invisible (the selection range is made invisible) with the processes up to step S1406. For example, even if the characteristic extraction is performed while a moving image or digital terrestrial broadcasting is being viewed, a display indicated by an erroneously displayed selection range can be made invisible.

In step S1414, the characteristic extraction process is executed. In step S1415, the position setting process is executed.

In step S1416, the display control unit 305 increments the variable Cnt by 1 (Cnt=Cnt+1), and sets the flag Flg to “1” indicating that the characteristic extraction has been performed (Flg=1). Additionally, the display control unit 305 activates the first timer.

When the control unit 2 (or the execution control unit 303) detects that an input has been made with an MF key in step S1417 (“YES” in step S1417), the flow goes to step S1419. Alternatively, when the control unit 2 (or the execution control unit 303) detects that the input has been made with a key other than the MF keys (“NO” in step S1417), the flow goes to step S1418.

In step S1418, the input made with the key other than the MF keys is controlled. For example, information input with a numeric key, a character input key or the like is converted into information utilized when the touch panel is used. Information corresponding to the operation performed with the key other than the MF keys is input to the input control unit 304 via the execution control unit 303. Upon termination of the process of step S1418, the flow goes back to step S1411.

In step S1419, the display control unit 305 determines whether or not the flag Flg is set to “1” indicating that the characteristic extraction has been performed (Flg=1). If the flag is set to “1” (“YES” in step S1419), the flow goes to step S1420. If the flag is not set to “1” (“NO” in step S1419), the flow goes back to step S1411.

In step S1420, the execution control unit 303 executes the execution control process.

In step S1421, the display control unit 305 determines whether or not a decision event (such as an event of updating the screen of the display panel) triggered by selecting a decision is present. When the decision event is present, the flow goes to step S1422. When the decision event is not present, the flow goes to step S1423.

In step S1422, the display control unit 305 sets, to 1, the variable Cnt indicating the number of times that the characteristic extraction is performed (Cnt=1). The display control unit 305 also sets the flag Flg, which indicates whether or not the characteristic extraction has been performed, to “0” indicating that the feature extraction is not performed (Flg=0). Additionally, the display control unit 305 activates the first timer. Upon termination of the process in step S1423, the flow goes back to step S1411.

Namely, while the screen is being updated by an application after a display portion (such as an icon, a button or the like) corresponding to the currently selected characteristic range has been decided with the Enter key, an input made with an MF key is invalidated.

In step S1423, the display control unit 305 sets the variable Cnt, which indicates the number of times that the characteristic extraction has been performed, to 1 (Cnt=1). Moreover, the display control unit 305 activates the first timer. Upon termination of the process in step S1423, the flow goes back to step S1411.

According to the second embodiment, an effect is produced such that even an application program employing a touch panel as a user interface can be operated with an MF key without adding, to the application program, a process corresponding to an operation performed with the MF key such as an arrow key, the Enter key or the like.

Additionally, according to the second embodiment, When no input is made for a predetermined duration, it is recognized that no operation is performed (for example, a screen is left unchanged), and a selected range is made invisible, leading to reductions in power consumption.

Furthermore, while a screen displayed on the display panel is being updated after the currently selected display portion (such as an icon, a button or the like) has been decided, an input made with an MF key is invalidated.

The present invention is not limited to the above described first and second embodiments, and can be variously improved and modified in a scope that does not depart from the gist of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relates to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. An information processing apparatus that can execute an application program and has a display panel, comprising:
a characteristic extraction unit configured to extract a characteristic range by executing a characteristic extraction process for an image displayed on the display panel;
a position setting unit configured to generate position setting information by making an association between the characteristic range and position coordinates indicating a position of the characteristic range on the display panel, and to store the position setting information in a storage unit; and
an execution control unit configured to
select a characteristic range at position coordinates present in a direction indicated by an arrow key by referencing the position setting information with the use of the direction indicated by the arrow key when an input is made with the arrow key, and control a display of the display panel based on selection range information indicating a display portion that is displayed on the display panel and corresponds to the characteristic range, and selection display information indicating how to display the display portion,
when a display portion of the display panel, which corresponds to the currently selected characteristic range is selected by using an Enter key, generate decision information indicating that the display portion is selected, and control execution of the application program based on the decision information.

2. The information processing apparatus according to claim 1, wherein
the position setting unit selects a characteristic range close to predetermined position coordinates on the display panel when a characteristic range is not stored in the storage unit.

3. The information processing apparatus according to claim 1, wherein
the execution control unit detects a characteristic range by referencing the position setting information in a predetermined order when the characteristic range is not present in the direction indicated by the arrow key.

4. The information processing apparatus according to claim 1, wherein
the execution control unit generates display range information for displaying another screen by scrolling a currently displayed screen when the currently selected characteristic range is positioned at an end of the display panel, and a direction indicated by a received arrow key indicates an outside of the display panel.

5. The information processing apparatus according to claim 1, wherein
a display indicating that a display portion displayed on the display panel is being selected is made invisible when no inputs from arrow keys and the Enter key are made for a predetermined duration.

6. The information processing apparatus according to claim 1, wherein
decision information newly received while a screen of the display panel is being updated is invalidated.

7. An information processing method executed by a computer, comprising:
extracting a characteristic range by executing a characteristic extraction process for an image displayed on the display panel;
generating position setting information by making an association between the characteristic range and position coordinates indicating a position of the characteristic range on the display panel, and storing the position setting information in a storage unit;
selecting a characteristic range at position coordinates present in a direction indicated by an arrow key by referencing the position setting information with the use of the direction indicated by the arrow key when an input is made with the arrow key, and controlling a display of the display panel based on selection range information indicating a display portion that is displayed on the display panel and corresponds to the characteristic range, and selection display information indicating how to display the display portion; and
when a display portion of the display panel, which corresponds to the currently selected characteristic range is selected by using an Enter key, generating decision information indicating that the display portion is selected, and controlling execution of the application program based on the decision information.

8. The information processing method according to claim 7, wherein
the computer selects a characteristic range close to predetermined position coordinates on the display panel when a characteristic range is not stored in the storage unit.

9. The information processing apparatus according to claim 7, wherein
the computer detects a characteristic range by referencing the position setting information in a predetermined order when the characteristic range is not present in the direction indicated by the arrow key.

10. The information processing method according to claim 7, wherein
the computer generates display range information for displaying another screen by scrolling a currently displayed screen when the currently selected characteristic range is positioned at an end of the display panel, and a direction indicated by a received arrow key indicates an outside of the display panel.

11. The information processing method according to claim 7, wherein
the computer makes a display indicating that a display portion displayed on the display panel is being selected invisible when no inputs from arrow keys and the Enter key are made for a predetermined duration.

12. The information processing method according to claim 7, wherein
the computer invalidates decision information newly received while a screen of the display panel is being updated.

13. A computer-readable recording medium having stored therein a program for causing a computer to execute an information processing process comprising:
extracting a characteristic range by executing a characteristic extraction process for an image displayed on the display panel; program for
generating position setting information by making an association between the characteristic range and position coordinates indicating a position of the characteristic range on the display panel, and storing the position setting information in a storage unit; and
selecting a characteristic range at position coordinates present in a direction indicated by an arrow key by referencing the position setting information with the use of the direction indicated by the arrow key when an input is made with the arrow key, and controlling a display of the display panel based on selection range information indicating a display portion that is displayed on the display panel and corresponds to the characteristic range, and selection display information indicating how to display the display portion; and
when a display portion of the display panel, which corresponds to the currently selected characteristic range is selected by using an Enter key, generating decision information indicating that the display portion is selected, and controlling execution of the application program based on the decision information.

14. The recording medium according to claim 13, the process further comprising
selecting a characteristic range close to predetermined position coordinates on the display panel when a characteristic range is not stored in the storage unit.

15. The recording medium according to claim 13, the process further comprising
detecting a characteristic range by referencing the position setting information in a predetermined order when the characteristic range is not present in the direction indicated by the arrow key.

16. The recording medium according to claim 13, the process further comprising
generating display range information for displaying another screen by scrolling a currently displayed screen when the currently selected characteristic range is positioned at an end of the display panel, and a direction indicated by a received arrow key indicates an outside of the display panel.

17. The recording medium according to claim 13, the process further comprising
making a display indicating that a display portion displayed on the display panel is being selected invisible when no inputs from arrow keys and the Enter key are made for a predetermined duration.

18. The recording medium according to claim 13, the process further comprising
invalidating decision information newly received while a screen of the display panel is being updated.
